(19) United States
(12) Patent Application Publication
(10) Pub. No.: US 2008/0163264 A1
(43) Pub. Date: Jul. 3, 2008

(54) Directory Service that Provides Information from a Plurality of Disparate Data Sources

(75) Inventors: Suneil H. Berajawala, Lowell, MA (US); Colleen S. Connearney, Arlington, MA (US); Patrick Y. Lin, Lexington, MA (US); Christopher R. Seekamp, Boca Raton, FL (US); Ajamu Wesley, Marlborough, MA (US)

Correspondence Address: CUENOT & FORSYTHE, L.L.C., 12230 FOREST HILL BLVD., STE. 120, WELLINGTON, FL, 33414, US

(73) Assignee: INTERNATIONAL BUSINESS MACHINES CORPORATION, Armonk, NY (US)

(21) Appl. No.: 11/617,448

(22) Filed: Dec. 28, 2006

(51) Int. Cl. G06F 9/46

(52) U.S. Cl. 719/328; 707/E17.008

(57) ABSTRACT

At least a first application program interface (API) may be provided to support retrieval of data from a plurality of disparate data sources. A directory from which data from at least one of the disparate data sources is exposed may be provided. Requested data may be automatically provided in response to the data being available via the directory.

### BACKGROUND OF THE INVENTION

A “white pages” application refers to a type of computer program that provides similar functionality as is provided by white pages telephone directories distributed in print form. Typically, a white pages application can provide, upon request, names, addresses, and/or telephone numbers. White pages applications also can provide additional information as well. For example, a white pages application can specify file services, print services, and other information that may be presented in the form of a directory.

In addition to information that may be resident within a white pages application itself, in some situations it would be beneficial to draw information from a plurality of other disparate data sources that are independent of the white pages application. Unfortunately, modern white pages applications oftentimes are not compatible with other data sources, for instance legacy data sources, spreadsheet files, and the like, and thus may not be able to access data contained therein. Moreover, white pages applications also may be incompatible with third party applications that require information provided by the white pages applications. For example, such third party applications may not communicate in accordance with the directory access protocols required to access data from the white pages applications. Thus, to properly integrate a modern white pages application into an existing information system, significant resources may be required to perform data conversion on existing data and to train employees to use new applications that access and process such data.

### BRIEF SUMMARY OF THE INVENTION

The present invention is directed to providing access to data provided by a plurality of disparate data sources. One embodiment of the present invention can include a method of providing access to data provided by a plurality of disparate data sources. The method can include providing at least a first application program interface (API) to support retrieval of data from a plurality of disparate data sources, providing a directory from which data from at least one of the disparate data sources is exposed, and determining whether the requested data is available via the directory in response to receiving a request for data from an application. The method also can include automatically providing the requested data in response to the data being available via the directory, or determining whether at least a second data source is available to provide the requested data in response to the data not being available via the directory.

Another embodiment of the present invention can include a method which includes providing at least a first application program interface (API) to support retrieval of data from a plurality of disparate data sources, providing a directory from which data from at least one of the disparate data sources is exposed, and automatically providing the requested data in response to the data being available via the directory.

Yet another embodiment of the present invention can include a machine readable storage being programmed to cause a machine to perform the various steps and/or functions described herein.

### BRIEF DESCRIPTION OF THE SEVERAL VIEWS OF THE DRAWINGS

FIG. 1 is a block diagram illustrating a system in accordance with an aspect of the present invention.

FIG. 2 is a flow chart illustrating a method in accordance with an aspect of the present invention.

### DETAILED DESCRIPTION OF THE INVENTION

As will be appreciated by one skilled in the art, the present invention may be embodied as a method, system, or computer program product. Accordingly, the present invention may take the form of an entirely hardware embodiment, an entirely software embodiment, including firmware, resident software, micro-code, etc., or an embodiment combining software and hardware aspects that may all generally be referred to herein as a “circuit”, “module”, or “system”.

Furthermore, the invention may take the form of a computer program product accessible from a computer-usable or computer-readable medium providing program code for use by, or in connection with, a computer or any instruction execution system. For the purposes of this description, a computer-usable or computer-readable medium can be any apparatus that can contain, store, communicate, propagate, or transport the program for use by, or in connection with, the instruction execution system, apparatus, or device.

Any suitable computer-usable or computer-readable medium may be utilized. The medium can be, for example, but is not limited to, an electronic, magnetic, optical, electromagnetic, infrared, or semiconductor system (or apparatus or device), or a propagation medium. A non-exhaustive list of exemplary computer-readable media can include an electrical connection having one or more wires, an optical fiber, magnetic storage devices such as magnetic tape, a removable computer diskette, a portable computer diskette, a hard disk, a rigid magnetic disk, an optical storage medium, such as an optical disk including a compact disk-read only memory (CD-ROM), a compact disk-read/write (CD-R/W), or a DVD, or a semiconductor or solid state memory including, but not limited to, a random access memory (RAM), a read-only memory (ROM), or an erasable programmable read-only memory (EPROM or Flash memory).

A computer-usable or computer-readable medium further can include a transmission media such as those supporting the Internet or an intranet. Further, the computer-usable medium may include a propagated data signal with the computer-usable program code embodied therewith, either in baseband or as part of a carrier wave. The computer-usable program code may be transmitted using any appropriate medium, including but not limited to the Internet, wireline, optical fiber, cable, RF, etc.

In another aspect, the computer-usable or computer-readable medium can be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems, and Ethernet cards are just a few of the currently available types of network adapters.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention relates to a method and a system for providing access to data provided by a plurality of disparate data sources. Moreover, such data access can be provided to a plurality of different applications requesting such data. Accordingly, modern data directories can be implemented into information systems which utilize other types of data structures, without requiring significant data conversion or employee training.

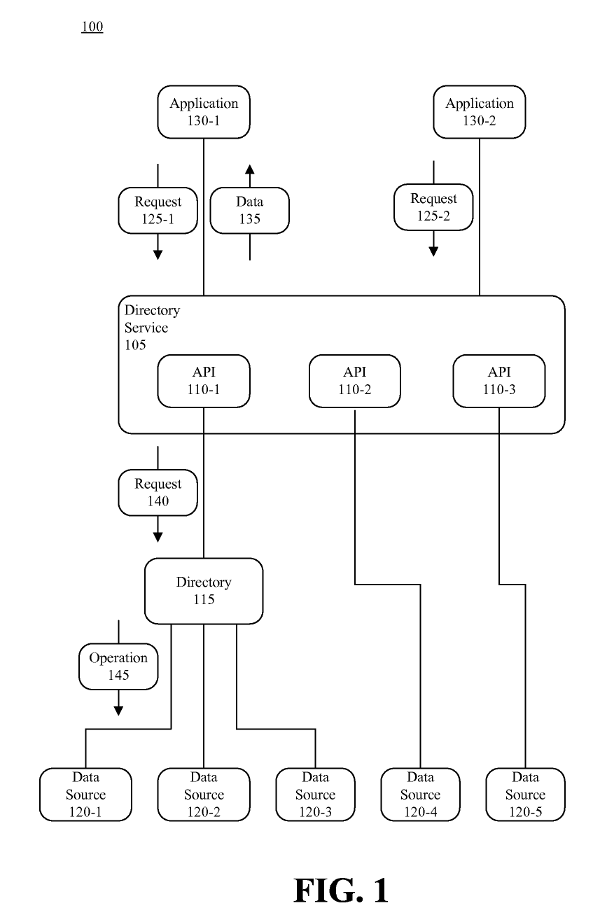

FIG. 1 is a block diagram illustrating a system 100 in accordance with one aspect of the present invention. The system 100 can include a directory service 105, which can comprise a plurality of application program interfaces (APIs) 110-1, 110-2, 110-3 that support data retrieval. In one arrangement, the directory service 105 can be implemented as a Java archives The Java archive can be commonly shared and easily reusable for developing and running distributed multi-tier architecture Java applications in the Java 2 Enterprise Environment.

The API 110-1 can be configured to retrieve data from a directory 115. The directory 115 can provide metadata generated from information exposed by a plurality of disparate data sources 120, such as data sources 120-1, 120-2 and 120-3. Examples of such data sources can include, but are not limited to, directories, databases, spreadsheets, collaborative systems, lightweight directory access protocol (LDAP) servers, applications used for human resources, customer relationship management and enterprise resource planning, and other corporate applications. As such, the data sources 120 can be profile providers in that they provide profiles of persons (e.g. persona information) or other profile information. As used herein, such information is referred to as “metadata.”

In one arrangement, data from the data sources 120-1, 120-2 and 120-3 can be automatically extracted and stored into a directory 115. In such an arrangement, updates to the directory 115 can be performed at periodic intervals, or in response to an event or request. The data can be maintained in the directory 115 in accordance with an X.500 inetOrgPerson LDAP object class.

The automated data extraction can be performed using the IBM® Tivoli® Directory Integrator (IBM and Tivoli are trademarks of International Business Machines Corporation in the United States, other countries, or both). The data can be exposed from the directory 115 using an ATOM feed. An ATOM feed is a communication link in accordance with the Atom Publishing Protocol, which is a hyper text transfer protocol (HTTP) based protocol for creating and updating HTTP resources.

In another arrangement, the directory 115 can be a virtual directory. As used herein, a virtual directory is a server for a directory protocol and does not itself store the data. Instead, the virtual directory can dynamically translate requests that it receives to operations in other protocols or data models, and communicate the operations to one or more of the data sources 120-1, 120-2, 120-3. Such requests can be processed to extract the data from the data sources 120-1, 120-2, 120-3 in real time. As used herein, the term “real time” means a level of processing responsiveness that a user senses as sufficiently immediate or that enables the processor to keep up with some external process.

The APIs 110-2, 110-3 can be configured to support retrieval of information from a particular type of data source 120. For example, the second API 110-2 can be configured to support retrieval of information exposed by a data source 120-4, and a third API 110-3 can be configured to support retrieval of information exposed by a data source 120-5. In one arrangement, the data source 120-4 can be a virtual member manager (VMM) and the API 110-2 can be a VMM API. Similarly, the data source 120-5 can be an LDAP server and the API 110-3 can be a Java naming and directory interface (JNDI) API. The API 110-1 can be an HTTP API that implements a remote service providing consolidated profile data from disparate data sources in the form of a consistent API.

The API 110 selection can be determined dynamically based on the hosting environment and configuration settings of a user repository provided by an application server. For example, the HTTP API 110-1 may be preferred, although the JNDI API 110-3 can be used in a standard application server environment. Similarly, the VMM API 110-2 may be used in specific WebSphere® application server environments (WebSphere is a trademark of International Business Machines Corporation in the United States, other countries, or both). The directory service 105 can provide an override mechanism as well to allow applications to by-pass auto-detection of API selection enforcement.

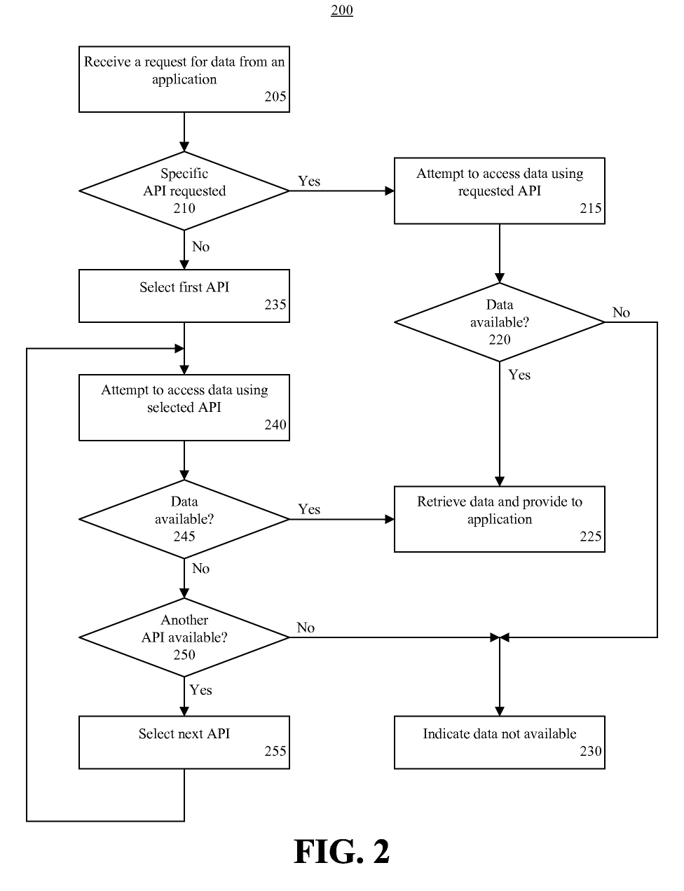

FIG. 2 is a flow chart illustrating a method 200 in accordance with an aspect of the present invention. Referring both to FIG. 1 and FIG. 2, the process can begin in a state in which the directory service 105 has been made available for use by one or more applications 130. At step 205 the directory service 105 can receive a request 125-1 for data from an application 130-1. The directory service 105 also can receive requests for data from other applications as well. For instance, the directory service 105 can receive a request 125-2 from an application 130-2.

In one arrangement, the requests 125 can be communicated in accordance with the HTTP protocol. For example, the requests 125 can be communicated to a particular uniform resource locator (URL) assigned to the directory service 105. In another arrangement, the requests 125 also can be communicated in accordance with another suitable protocol, for example, ATOM, JSON, RSS and/or XCard.

Referring to decision box 210, if a specific API 110 is requested, at step 215 the directory service 105 can attempt to access the requested data using the requested API 110. For instance, if the request 125-1 requests that the API 110-3 be used to access the requested data, the directory service 105 can dynamically direct the request to a URL associated with the API 110-3. Referring to decision box 220, if the requested data is available, for instance at the data source 120-5, the process can proceed to step 225 and the directory service 105 can retrieve the requested data 135 using the requested API 110-3. The directory service 105 then can provide the requested data 135 to the application 130-1 from which the request 125-1 is initiated. If, however, the requested data is not available using the requested API 110-3, at step 230 a message can be communicated to the application 130-1 indicating that the data is not available via the requested API 1110-3.

Referring again to decision box 210, if a specific API 110 was not requested, at step 235 a first API 110 can be selected by the directory service 105, for instance the API 110-1 can be selected. As noted, the API 110-1 can be selected by dynamically directing the request to a URL associated with the API 110-1. In an arrangement in which the API 110-1 supports retrieval of data via the directory 115 and the directory 115 is a virtual directory, the API 110-1 can be accessed by the directory service 105 to generate an appropriate request 140 to the directory 115. The directory 115 then can dynamically translate the request 140 to an operation 145 in a suitable protocol or data model, and communicate the operation to a data source 120 having the requested data, for instance the data source 120-1. Alternatively, in an arrangement in which the requested data may be stored in the directory 115 itself, the directory service 105 can attempt to extract the data from the directory 115 using a suitable operation.

Referring to decision box 245, if the requested data is available, at step 225 the data can be retrieved. For instance, if the directory 115 is a virtual directory, the data 135 then can be extracted from the data source 120-1 and communicated to the application 130-1. If, however, the data is stored in the directory 115 itself, the directory service 105 can extract the data 135 from the directory 115 and communicate the requested data 135 to the application 130-1.

If the requested data is not available from data sources 120-1, 120-2, 120-3 associated with the directory 115, the process can proceed to decision box 250, and the directory service 105 can determine whether another API 110 is available. If not, at step 230 the directory service 105 can provide an indication to the application 130-1 indicating that the requested data is not available. If there is another API that is available, at step 255 the directory service 105 can select another API, for example API 110-2. The process can return to step 240 and the directory service 105 can attempt to access the data using the API 110-2, for instance from the data source 120-4.

Again referring to decision box 245, if the requested data is not available from the data source 120-4, the process can proceed to decision box 250 and if another API is available, for instance API 110-3, at step 255 the directory service 105 can select the API 110-3. Again returning to step 240, the directory service 105 can attempt to access the data from the data source 120-5. The process can continue until the data has been retrieved and provided to the application, as shown in step 225, or there are no further APIs 110 which have not already been used to attempt to access the requested data. In that case the process can proceed to step 230 and indicate that the requested data is not available.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to the embodiments thereof, it will be apparent that modifications and variations are possible without departing from the scope of the invention defined in the appended claims.

What is claimed is:

1. A method of providing access to data provided by a plurality of disparate data sources, comprising:
providing at least a first application program interface (API) to support retrieval of data from a plurality of disparate data sources;
providing a directory from which data from at least one of the disparate data sources is exposed;
responsive to receiving a request for data from an application, determining whether the requested data is available via the directory; and
automatically providing the requested data in response to the data being available via the directory, or determining whether at least a second data source is available to provide the requested data in response to the data not being available via the directory.

2. The method of claim 1, wherein providing the directory comprises providing a virtual directory.

3. The method of claim 1, wherein providing the requested data comprises providing metadata.

4. The method of claim 1, wherein providing the first API comprises providing an API that supports retrieval of requested data from via the directory, further comprising providing a second API that supports retrieval of requested data from the second data source.

5. The method of claim 4, wherein providing the second API comprises providing a virtual member manager (VMM) API.

6. The method of claim 4, wherein providing the first and second APIs comprises providing the first and second APIs in a directory service.

7. The method of claim 6, wherein providing the first and second APIs in a directory service comprises implementing the directory service as a Java archive.

8. The method of claim 1, further comprising:
providing the requested data from the second data source in response to the data being available from the second data source, or determining whether at least a third data source is available to provide the requested data in response to the data not being available from the second data source.

9. The method of claim 8, further comprising providing a third API that supports retrieval of the requested data from the third data source.

10. The method of claim 9, wherein providing the third API comprises providing a Java naming and directory interface (JNDI) API.

11. The method of claim 1, wherein receiving the request for the data comprises receiving an HTTP request.

12. A method of providing access to data provided by a plurality of disparate data sources, comprising:
providing at least a first application program interface (API) to support retrieval of data from a plurality of disparate data sources;
providing a directory from which data from at least one of the disparate data sources is exposed; and
automatically providing the requested data in response to the data being available via the directory.

13. The method of claim 12, wherein providing the directory comprises providing a virtual directory.

14. A computer program product comprising:
a computer usable medium having computer usable program code that provides access to data provided by a plurality of disparate data sources, said computer program product including:
computer usable program code that provides at least a first application program interface (API) to support retrieval of data from a plurality of disparate data sources;
computer usable program code that provides a directory from which data from at least one of the disparate data sources is exposed;
computer usable program code that, responsive to receiving a request for data from an application, determines whether the requested data is available via the directory; and
computer usable program code that automatically provides the requested data in response to the data being available via the directory, or determines whether at least a second data source is available to provide the requested data in response to the data not being available via the directory.

15. The computer program product of claim 14, wherein the computer usable program code that provides the directory comprises computer usable program code that provides a virtual directory.

16. The computer program product of claim 14, wherein the computer usable program code that provides the first API comprises computer usable program code that provides an API that supports retrieval of requested data from via the directory, the computer program product further comprising computer usable program code that provides a second API that supports retrieval of requested data from the second data source.

17. The computer program product of claim 16, wherein the computer usable program code that provides the first and second APIs comprises computer usable program code that provides the first and second APIs in a directory service.

18. The computer program product of claim 14, further comprising:
computer usable program code that provides the requested data from the second data source in response to the data being available from the second data source, or determines whether at least a third data source is available to provide the requested data in response to the data not being available from the second data source.

19. The computer program product of claim 18, further comprising computer usable program code that provides a third API that supports retrieval of the requested data from the third data source.

20. The computer program product of claim 14, wherein the computer usable program code that receives the request for the data comprises computer usable program code that receives an HTTP request.
